(19) United States
(12) Patent Application Publication
(10) Pub. No.: US 2026/0264328 A1
(43) Pub. Date: Sep. 10, 2026

(54) PRINT HEAD FOR OXIDIZER-DOPED FUEL GRAIN

(71) Applicant: Vaya Space, Inc., Cocoa, FL (US)

(72) Inventors: Kineo M. Wallace, Cocoa, FL (US); Lucas Long, Cocoa, FL (US); Brian Deyo, Cocoa, FL (US); Carlos Padilla, Cocoa, FL (US)

(73) Assignee: VAYA SPACE, INC., Cocoa, FL (US)

(21) Appl. No.: 19/556,691

(22) Filed: Mar. 4, 2026

Related U.S. Application Data
(60) Provisional application No. 63/766,812, filed on Mar. 4, 2025.

(51) Int. Cl. B29C 64/209; B29C 64/165; B29C 64/295; B29C 64/314; B29C 64/329; B29C 64/393; B29L 31/20; B33Y 30/00; B33Y 50/02

(52) U.S. Cl. CPC B29C 64/209; B29C 64/165; B29C 64/295; B29C 64/314; B29C 64/329; B29C 64/393; B29L 2031/20; B33Y 30/00; B33Y 50/02

(57) ABSTRACT

A device includes a print head. The print head includes a heating segment, a mixing segment, a pumping segment and a nozzle. The print head includes a heater and a first extruder. The heating segment includes a first enclosed section of the print head, the heater being configured to apply heat inside the first enclosed section. The first extruder is configured to rotate. The heating segment is configured to receive binder polymer and heat the binder polymer into a liquid binder polymer. The mixing segment includes a mixer. The mixing segment includes a second enclosed section of the print head. The mixing segment is configured to receive the liquid binder polymer and additives in the second enclosed section and mix the liquid binder polymer and the additives to form a mixture. The pumping segment includes a second extruder.

This non-provisional application claims the benefit under 35 U.S.C. § 119(e) to U.S. Provisional Application No. 63/766,812, filed on Mar. 4, 2025, which is hereby expressly incorporated by reference into the present application.

### BACKGROUND

Fuel grains can be mixed with solid oxidizers to make a solid fuel for a rocket engine. Fuel grains without a solid oxidizer included can be used in hybrid rocket engines, which also use a liquid oxidizer that is injected into the combustion chamber when the solid fuel is burned. Solid fuel grains which do not include a solid oxidizer mixed into the fuel grain are more difficult to ignite. Solid fuel grains which do include a solid oxidizer mix into the fuel grain are easier to ignite but are also more sensitive to shock and vibration. Solid fuel grains which do include a solid oxidizer mixed into the fuel grain are also more dangerous to manufacture and store because the oxidizer and fuel are combined before the time of ignition.

Traditional manufacturing of solid rocket fuel grains, for both solid and hybrid rocket motors, has been predominantly achieved through casting processes. The established method involves utilizing a thermoset polymer binder, typically Hydroxyl Terminated Polybutadiene (HTPB), into which various additives are mixed. This highly viscous mixture, in liquid resin form, is then poured into a mold and cast into the desired shape. For hybrid rocket fuel grains using paraffin wax a similar casting approach is employed, often incorporating energetic additives like aluminum or boron powder into the molten wax before molding.

These traditional casting methods, while well-established, present inherent limitations, particularly concerning mixing and degassing. The process of mixing additives, especially solid particulates and energetic materials, into highly viscous thermoset resins or molten wax is inherently challenging. Even with thorough mechanical mixing, it is difficult to achieve uniform additive distribution, and agglomeration of particles can occur. During the mixing and pouring of the liquid resin in casting, air can be introduced and entrapped within the viscous mixture. In casting, the mixed propellant slurry is typically subjected to a separate degassing step in a vacuum chamber to remove this entrapped air and volatiles before curing. While this post-mixing degassing step is somewhat effective, it adds to the manufacturing time and complexity.

The rise of Additive Manufacturing (AM) offered a paradigm shift, promising greater design freedom for complex fuel grain geometries and potentially streamlined production. However, early AM approaches, particularly those based on Fused Deposition Modeling (FDM), introduced their own set of limitations, compounded by challenges in material processing. The layer-by-layer construction inherent in FDM and similar techniques often results in anisotropic material properties and micro-gaps between layers. Individual layers typically adhere to each other but do not fully fuse at a molecular level, leading to inconsistent density, delamination, and unpredictable structural and combustion behavior. As highlighted in studies like “Pyrolysis of Acrylonitrile-Butadiene-Styrene (ABS) Under High Heat Flux Conditions” by Whitmore et al., these imperfections and voids in AM-produced fuels can negatively impact propellant density and regression rates. Furthermore, in screw extrusion-based AM, air bubbles can become trapped between the polymer pellets as they melt within the extruder, contributing to porosity in the final printed part.

Furthermore, current AM approaches for hybrid rocket fuels often necessitate pre-mixing additives into the polymer feedstock in a separate process before extrusion. This pre-compounding step introduces several inefficiencies and risks. Reprocessing polymers multiple times increases manufacturing cost and time. More importantly, for volatile energetic additives, each reprocessing step increases the risk of adverse effects such as degradation, volatilization, or even unintended reactions due to heat and sheer. Attempting to directly incorporate additives into a traditional FDM printer without pre-compounding and degassing exacerbates the problem. The surface tension of powder additives in a polymer melt tends to increase porosity in the printed part. This porosity is highly detrimental in rocket fuel grains.

In solid rocket motors, porosity can create voids and cracks that can propagate under pressure, leading to structural failure and even explosions. In hybrid rocket motors, porosity is equally problematic but also contributes to other performance limitations. Cracks can lead to fuel fragments breaking off and potentially plugging the nozzle throat, causing thrust instabilities or failure. Beyond structural issues, porosity directly reduces the density of the fuel grain, decreasing volumetric loading efficiency and overall motor performance, as more volume is occupied by voids rather than propellant. Hybrid rocket engines also suffer from ignition challenges. Traditional hybrid rocket ignition relies on the heat flux from the oxidizer flow pyrolyzing the solid fuel surface to generate fuel vapor for combustion. This process can lead to slow startup transients and ignition delays, limiting the tactical applications of hybrid rockets. Furthermore, hybrid rockets are susceptible to the “flooding limit” phenomenon, where excessive oxidizer mass flux can lead to a condition where “too much oxidizer limits the ability to burn.” This occurs when the oxidizer mass flow rate is so high that it stagnates or reduces the fuel regression rate, leading to incomplete combustion and reduced performance. As explained by Andøya Space Education, “Too high mass flux can lead to flooding, meaning too much oxidizer limits the ability to burn. The regression rate level will stagnate.” Chiaverini et al. (2000) also note the phenomenon of “Flooding” in hybrid rocket combustion, further emphasizing its importance Mitigating the flooding limit and achieving stable, efficient combustion across a wider range of oxidizer flow rates remains a key challenge in hybrid rocket design.

Beyond rocket propulsion, additive manufacturing is increasingly utilized for thermoplastic composites. However, achieving high performance in these materials requires high volume fractions of reinforcing fibers (e.g., carbon fiber, fiberglass) to enhance strength and stiffness. Traditional extrusion-based AM methods struggle to incorporate high fiber loading effectively. High fiber content in thermoplastic melts significantly increases viscosity and reduces flowability, making uniform mixing and extrusion difficult. Furthermore, the introduction of high fiber volumes exacerbates the porosity problem, as air can become trapped around the fibers during mixing and extrusion, leading to void-rich composite parts with compromised mechanical properties. Current methods often result in fiber misalignment, agglomeration, and poor fiber-matrix bonding due to inadequate mixing and degassing within conventional extruders.

Large-format FDM 3D printers, such as those manufactured by Thermwood Corporation (e.g., the Thermwood LSAM) and Cincinnati Incorporated (e.g., the Cincinnati BAAM), exemplify the limitations of current large-scale extrusion-based AM technology. While these machines offer impressive build volumes for large parts, they typically rely on single-screw extruders. These single-screw designs, particularly when scaled up for large format printing, often struggle to provide adequate mixing and degassing, especially when processing highly filled materials or advanced formulations. The long residence times and limited mixing efficiency in large single-screw extruders can exacerbate issues with thermal degradation, volatile loss, and porosity, restricting the range of materials and applications for these large-format AM systems.

However, existing AM approaches fail to provide a comprehensive and integrated solution for the multifaceted challenges of in-situ mixing, vacuum degassing, dynamic composition control, ignition enhancement, flooding limit mitigation, and high-fiber loading in thermoplastic composites, all directly within the AM extrusion system. They do not address the fundamental limitations of traditional single-screw extruders in these demanding applications. The problems of pre-mixing, reprocessing, porosity, ignition delays, flooding, and inadequate composite performance remain largely unaddressed by the current state of the art.

### SUMMARY

A multi-screw extrusion system for additive manufacturing is disclosed that integrates in-situ mixing, vacuum degassing, and dynamic composition control within a compact extrusion head. The system overcomes limitations of traditional casting and single-screw extrusion methods, particularly in producing advanced composite materials such as high-performance rocket fuels and thermoplastic composites. Components include a multi-screw extruder barrel with zoned induction heating, a multi-stage vacuum hopper system with a rotary metering valve incorporating a vacuum purge, a vacuum mixing chamber housing an intermeshing co-and counter-rotating screw agitator with enhanced surface area mixing elements (e.g., pineapple mixing sections), a spiral melt flow pump, and a dynamic nozzle aperture. The integrated vacuum system minimizes porosity, while in-situ mixing ensures homogeneous material compositions, and dynamic control enables tailored material properties and gradient structures. This system offers significant advantages, including enhanced mixing and homogeneity, reduced porosity, expanded material range, streamlined manufacturing, and improved safety, particularly for applications in rocket propulsion, aerospace composites, chemical processing, and advanced materials research. The compact design and versatile capabilities of the multi-screw extrusion system provide a transformative platform for additive manufacturing of high-performance components with complex geometries and customized material properties, overcoming limitations of existing large-format single-screw extrusion AM systems and traditional casting methods.

A print head may be used in an additive manufacturing (AM) process of rapidly forming an isotropic fuel grain with no voids, or air bubbles by molecularly fusing the individual layers and beads. The fuel grain is formed of various layers on a mandrel which are subsequently fused and blended into the layer below it, producing one isentropic structure. A fuel composition of a solid propellant may also be changed using a gradient blending method transitioning from one mixture to another out from the central port by changing a fuel composition of the fuel material dynamically. For example, the fuel composition can be changed from an oxidizer-doped fuel grain (solid fuel mixed with solid oxidizer) to a non-oxidizer-doped fuel grain (fuel without an oxidizer). In this way a fuel grain with an interior layer doped with an oxidizer for easier ignition and an exterior layer not doped with the oxidizer for safer storage and greater overall fuel density can be formed through the additive manufacturing process.

A central port of the fuel grain may be formed around a negative of the desired shape of the central port allowing for complex geometries which improve burn characteristics of the fuel grain. This eliminates the need for post process reshaping of the central port of the fuel grain. The reduction in processing of an oxidizer-doped fuel grain also improves safety.

The print head also allows for other additives to be added to the fuel grain mix such as different fuel types, binders, metals, oxidizers, etc. The print head is not limited in use to only formation of rocket fuel. The print head may be used in any additive manufacturing process. For example, the print head may be used to mix different materials in any additive manufacturing process that relies on melting at least one of the materials before the mixture is deposited. Also dynamically tailored compositions and properties for diverse applications may be made, including chemical processing, pharmaceuticals, and specialized construction materials.

The multi-screw extrusion system for in-situ mixing additive manufacturing provides significant advantages across a wide range of applications due to its unique integration of mixing, degassing, and dynamic composition control. These advantages are particularly pronounced in demanding fields such as rocket propulsion and advanced composites. The system offers transformative benefits for both hybrid and solid rocket propulsion by enabling advanced performance, improved hybrid rocket operation, high density solid propellants and integral insulation. Superior mixing and homogeneity lead to more predictable and efficient combustion in both hybrid and solid rocket motors. Reduced porosity increases fuel grain density and structural integrity, maximizing performance and safety. In-situ solid oxidizer doping addresses the “flooding limit,” while dynamic composition control enables fuel grains with gradient oxidizer concentrations for improved ignition and tailored burn characteristics. Production of void-free solid rocket fuel grains with high loadings of energetic additives, ensuring consistent and powerful propellant performance. Direct AM of foam insulation layers onto fuel grains simplifies motor design and enhances thermal management. The system may be applied to form hybrid rocket fuel grains, solid rocket motor propellants, and insulated rocket motor casings.

The system overcomes limitations in conventional thermoplastic composite AM by having superior mechanical properties such as high fiber loading, uniform fiber dispersion, and reduced porosity which result in thermoplastic composite parts with significantly enhanced strength, stiffness, and toughness. The system provides the advantage of allowing for complex geometries where using additive manufacturing enables the creation of complex and optimized composite geometries not achievable with traditional methods. The system likewise provides the advantage of forming lightweight high performance thermoplastic composites which offer significant weight reduction compared to metals, beneficial for aerospace, automotive, and other weight-sensitive applications.

The system is applicable to aerospace structures such as manufacturing lightweight and robust structural components for aircraft, spacecraft, and UAVs. The system is applicable to automotive components such as producing high-strength, lightweight parts for vehicles, improving fuel efficiency and performance. The system is also applicable to creating advanced composite materials for high-performance sporting equipment.

Beyond propulsion and composites, the system's core capabilities provide broad advantages for materials manufacturing. Precise control over polymer blends and additive concentrations allows for creating materials with customized properties for specific needs. An ability to process diverse polymers and incorporate a wide variety of additives expands the spectrum of materials achievable through additive manufacturing. In-situ mixing and direct extrusion eliminate pre-processing steps, reducing cost, time, and material waste. Integrated vacuum systems and controlled processing enhance safety, especially when handling energetic or volatile materials. The system has unique capability to create foam materials and insulation layers directly during printing. The multi-screw system addresses the inherent mixing and degassing limitations of large single-screw extruders used in current large-format AM systems, enabling the processing of a wider range of materials and the fabrication of higher-performance large-scale parts. The compact, low aspect ratio multi-screw extruder design leads to a significantly smaller extrusion head footprint compared to conventional large single-screw extruders. In large-format AM machines, this reduced footprint is crucial. It allows for either a more compact overall machine design for a given build volume, or, more importantly, for maximizing the usable build volume within a machine of comparable overall size. This optimization of build volume relative to machine footprint is a key advantage in large-scale additive manufacturing, increasing production efficiency and reducing floor space requirements.

The system also may be applied to advanced materials research (though rapid prototyping, material screening, and custom material design), high density ceramic (through manufacturing wear-resistant and high-temperature components) and specialized construction materials (through additive manufacturing of materials with tailored insulation or structural properties).

In an example embodiment, a device comprises a print head. The print head includes a heating segment including a heater and a first extruder, the heating segment including a first enclosed section of the print head, the heater being configured to apply heat inside the first enclosed section, the first extruder being configured to rotate, the heating segment being configured to receive binder polymer and heat the binder polymer into a liquid binder polymer; a mixing segment including a mixer, the mixing segment including a second enclosed section of the print head, the mixing segment configured to receive the liquid binder polymer and additives in the second enclosed section and mix the liquid binder polymer and the additives to form a mixture; a pumping segment including a second extruder, the pumping segment configured to receive the mixture and extrude the mixture; and a nozzle, wherein the second extruder is configured to extrude the mixture through the nozzle.

In an example embodiment, the heater is an inductive type heater or a resistance type heater configured to heat the first extruder.

In an example embodiment, the device further comprises a vacuum pump configured to remove air from the print head.

In an example embodiment, the first extruder includes a plurality of parallel screws configured to rotate to convey the binder polymer during a heating processing.

In an example embodiment, the nozzle is configured to change at least one of width and thickness of the extruded mixture.

In an example embodiment, the mixer includes a plurality of dynamic mixers.

In an example embodiment, the device further comprises a controller configured to control movement of the print head to print a fuel grain in an additive manufacturing process.

In an example embodiment, the controller is configured to control the print head in the additive manufacturing process to change a concentration of an additive among the additives in the mixture during the additive manufacturing process.

In an example embodiment, the controller is configured to control addition of air and a burn inhibiting additive to the binder polymer in the mixing segment.

In an example embodiment, the device further comprises a plurality of binder hoppers each including a dispenser, the plurality of binder hoppers each configured to hold the binder polymer, the dispenser including rotating chambers, each rotating chamber among the rotating chambers being configured to rotate to a first position where the binder polymer is received from the binder hopper, a second position where a vacuum pump is configured to remove air from the rotating chamber, and a third position where the binder polymer is conveyed to the heating segment.

In an example embodiment, the device further comprises a plurality of additive hoppers each including a conveyer, each of the plurality of additive hoppers configured to hold one of the additives, the conveyer configured to convey the one of the additives to the mixing segment.

In another example embodiment, A device comprises a plurality of binder hoppers and a print head. The plurality of binder hoppers each include a dispenser, the plurality of binder hoppers each configured to hold a binder polymer, the dispenser including rotating chambers, each rotating chamber among the rotating chambers being configured to rotate to a first position where the binder polymer is received from one of the plurality of binder hoppers, a second position where a vacuum pump is configured to remove air from the rotating chamber, and a third position where the binder polymer is conveyed to a heating segment. The print head includes the heating segment including a heater and a first extruder, the heating segment including a first enclosed section of the print head, the heater being configured to apply heat inside the first enclosed section, the first extruder being configured to rotate, the heating segment being configured to receive binder polymer and heat the binder polymer into a liquid binder polymer; and a nozzle configured to shape the liquid binder polymer as the liquid binder polymer exits the print head.

In an example embodiment, the print head further includes a mixing segment including a mixer, the mixing segment including a second enclosed section of the print head, the mixing segment configured to receive the liquid binder polymer and additives in the second enclosed section and mix the liquid binder polymer and the additives to form a mixture; and a pumping segment including a second extruder, the pumping segment configured to receive the mixture and extrude the mixture via the nozzle.

In an example embodiment, the device further comprises a plurality of additive hoppers each including a conveyer, each of the plurality of additive hoppers configured to hold one of the additives, the conveyer configured to convey the one of the additives to the mixing segment.

In an example embodiment, the first extruder includes a plurality of parallel screws configured to rotate to convey the binder polymer during a heating processing.

In an example embodiment, the device further comprises a controller configured to control movement of the print head to print a fuel grain in an additive manufacturing process.

In an example embodiment, the controller is configured to control a rotation rate of each of the rotating chambers to control a mixture composition of the liquid binder polymer.

In yet another example embodiment, a device comprises a plurality of binder hoppers each including a dispenser, the plurality of binder hoppers each configured to hold a binder polymer, the dispenser including rotating chambers, each rotating chamber among the rotating chambers being configured to rotate to a first position where the binder polymer is received from one of the plurality of binder hoppers, a second position where a vacuum pump is configured to remove air from the rotating chamber, and a third position where the binder polymer is conveyed to a heating segment; a print head including the heating segment including a heater and a first extruder, the heating segment including a first enclosed section of the print head, the heater being configured to apply heat inside the first enclosed section, the first extruder being configured to rotate, the heating segment being configured to receive binder polymer and heat the binder polymer into a liquid binder polymer; and a controller configured to control movement of the print head in an additive manufacturing process and a rotation rate of each of the rotating chambers to control a mixture composition of the liquid binder polymer.

In an example embodiment, the print head further includes a mixing segment including a mixer, the mixing segment including a second enclosed section of the print head, the mixing segment configured to receive the liquid binder polymer and additives in the second enclosed section and mix the liquid binder polymer and the additives to form a mixture; and a pumping segment including a second extruder, the pumping segment configured to receive the mixture and extrude the mixture. The controller is configured to control a rotation rate of the first extruder, a rotation rate of the mixer, and a rotation rate of the second extruder.

### BRIEF DESCRIPTION OF THE DRAWINGS

A brief description of the figures follows, where:

FIG. 1A is a schematic representation of an additive lathe according to an example embodiment;

FIG. 1B is a second view of the schematic representation of the additive lathe according to an example embodiment;

FIG. 2 shows a first embodiment of a print head depositing a propellant according to an example embodiment;

FIG. 3 shows a second embodiment of the print head depositing the propellant with a fiber reinforcement according to an example embodiment;

FIG. 4 is a cut away showing the inside of the print head and second hopper according to an example embodiment;

FIG. 5 is a flow chart of action taken by the second hoppers and print head according to an example embodiment;

FIG. 6 is a flow chart showing controls by the controller according to an example embodiment;

FIG. 7A is a side view of the fuel grain according to an example embodiment;

FIG. 7B is a bottom view of the fuel grain according to an example embodiment;

FIG. 8 is a schematic representation of a rocket with the fuel grain according to an example embodiment;

FIG. 9 shows a laser ignition for the rocket fuel grain according to an example embodiment;

FIG. 10A-C show a laser beam igniting the rocket fuel grain according to an example embodiment;

FIG. 11 is another cut away showing the inside of the print head and second hopper according to an example embodiment;

FIG. 12 is a cut away showing the inside of the upper print head and second hoppers according to an example embodiment;

FIG. 13 is a cut away showing the rotating dispenser according to an example embodiment;

FIG. 14 is a cut away showing the inside of the print head and second hoppers according to an example embodiment;

FIG. 15 is a cut away showing the inside of a mixing segment and a pumping segment of the printer head according to an example embodiment; and

FIG. 16 is a cut away showing a connection between the mixing segment and a conveyer according to an example embodiment.

### DETAILED DESCRIPTION OF EXAMPLE EMBODIMENTS

Example embodiments show an additive lathe 100 which can form a solid fuel grain 180. Example embodiments also disclose a method of forming the solid fuel grain 180. Example embodiments further disclose the composition of the solid fuel grain 180. The method of manufacture has the advantage of reducing the time of manufacture and producing a fuel grain 180 with reduced turbulence in the outflow of gases from a central port of the fuel grain 180 when burned as well as higher burn consistency and volumetric efficiency compared to other fuel grains formed by AM.

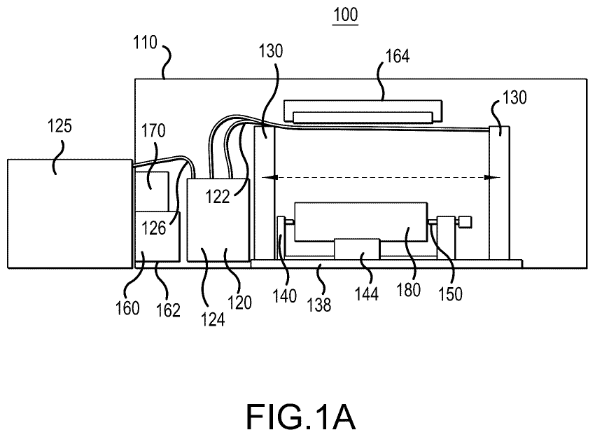

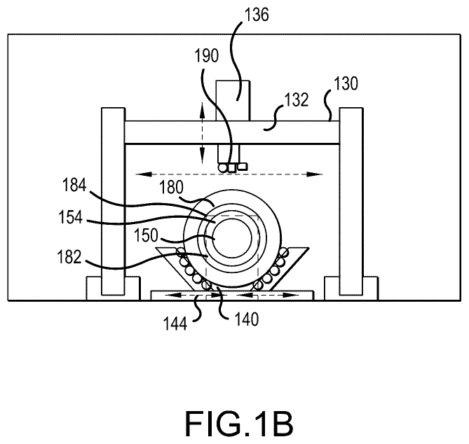

FIG. 1A is a schematic representation of an additive lathe according to an example embodiment. FIG. 1B is a second view of the schematic representation of the additive lathe according to an example embodiment. The additive lathe 100 may include an enclosure 110, a plurality of feed lines 120, one or more gantries 130, a chuck 140, a mandrel 150 with a fuel grain 180 formed on the mandrel 150, a thermal control unit 160 including an environment heater 162 and infrared lamps 164 and a controller 170. The enclosure 110 may be insulated and configured to maintain a temperature in the enclosure 110 and may also have ventilation or other systems to control harmful fumes, oxygen levels, or other environmental factors during operation.

The plurality of feed lines 120 may include hoppers 124 of feedstock pellets with various compositions and a plurality of feed lines 122. The fuel gain feed system may be an in-situ compounding system that can manufacture the feedstock pellets with different compositions including but not limited to different metals, oxidizers, polymers, and other additives. The in-situ compounding feed system allows dynamic incorporation of a vast array of additives, allowing for precise tailoring of the fuel grain's composition at a molecular level. This facilitates the optimization of burn rate, combustion efficiencies, impulse density, exhaust smoke characteristics, structural properties, and ignition characteristics. First hoppers 124 hold and dry the feedstock. The feedstock is then transferred through a conveying mechanism 122 that sends it into a second hopper 136 that feeds the feedstock into the print head 190 which melts the feedstock so that it can be applied in the additive manufacturing process. The fuel grain 180 may be composed of ABS (Acrylonitrile Butadiene Styrene) and/or HDPE (High Density Polyethylene), Polyethylene, Polyethylene Wax, Paraffin Wax, Styrene-ethylene-butylene-styrene (SEBS), Nylon, Polyoxymethylene (POM), or any other polymer suitable for thermoplastics processing. A drying stage precedes a vacuum or compressed air feed system that delivers the material to the hoppers of the print head. The system also incorporates a network of hoppers and precision feeders designed to introduce a wide variety of additives directly into the extruder system. This enables the dynamic, in-situ mixing of the primary fuel material with a vast array of performance-enhancing components. These can include metal powders to increase burn rate, temperature or fuel density; solid oxidizer powders to improve propellant ignitability or density; or pre-compounded polymers with tailored properties, such as SEBS that has absorbed an amphiphilic oil for modified burn characteristics, or varying quantities of paraffin wax to adjust regression rate. The composition of the melted (liquid) fuel grains can be changed by changing the rate at which differing feedstocks are fed into the extruder from the different hoppers.

In one embodiment, the infrared lamps 164 may be resistive, infrared, or Nano-wave deep infrared panels which maintain a targeted bulk temperature within the part (e.g., approximately 93° C. for HDPE annealing) to encourage material crystal growth and stress relief. This allows for a lower overall build chamber temperature, enhancing operator safety. A high-energy source (e.g., lasers) 196 precedes the print head, melting the previous layer's surface to ensure complete interlayer fusion. A network of thermal sensors (e.g., pyrometers) 195 monitors surface temperatures, enabling dynamic adjustments to the heating elements via a PID control algorithm. The pellet feed extruder may deposit material from less than 1 kg/h to greater than 1000 kg/h. The pellet feed hopper 124 may be fed by a pellet dryer and pellet auto vacuum feed 126 that maintains the material at a desired dried state and continuously feeds dried pellets into the hoppers 124. Additionally, a silo feed conveyer can be added to the feed system that would allow for multiple payloads of material to be fed from silos 125 into the pellet dryer 126 without the need of continual material addition throughout the duration of a long-term print.

The additive lathe 100 may include any number of gantries 130 which move on a track 138. A first gantry 130 may be used for depositing material on the mandrel 150 and a second gantry 130 may be used for milling, where the gantry 130 includes a spindle for milling the fuel grain 180 as it is rotated about the axis. Alternatively, both the first gantry and the second gantry may be used for depositing materials. For example, the first gantry may deposit a support material for a support layer 182, then the second gantry may deposit the propellant to form the fuel grain 180. While the second gantry is depositing the propellant the first gantry may have the material in the second hopper switched to an insulating material for an outer insulating layer 186 and after the fuel grain 180 is formed the first gantry may be used to deposit the outer insulating layer 186. An insulating layer 184 may be a paper material which is placed between the support material and the fuel grain 180 to insulate the support material from the heat of the propellant as it is deposited. The insulating layer 184 may be applied as a wrapping by hand or with a machine or may be applied in a semiliquid state such as a paper mâché by a gantry 130. Additionally, a plurality of gantries could produce a plurality of fuel grains along the length of the mandrel so as to maximize fuel grain production.

As shown in FIG. 1B, the gantry 130 may include an adjustable bridge gantry 132 that can move relative to a rotation axis of the mandrel 150 on the bracket 140. In some example embodiments, the gantry 130 can be replaced with a robotic arm. The adjustable gantry 132 may move perpendicular to the axis of rotation of the mandrel 150. Alternatively, the mandrel 150 may be moved on the bracket 140 relative to the adjustable arm 132. The adjustable gantry 132 may have a print head 190 movably mounted thereon. The print head 190 may be able to move in a direction parallel to the axis of rotation of the mandrel 150 with the gantry 130, by the gantry 130 moving on the track 138. The print head 190 may have a variety of sizes for a variety of desired thicknesses and desired number of turns per meter of each layer.

The bracket 140 may be configured to secure the mandrel 150 and have an actuator, electric motor or other mechanism of rotating the mandrel 150 on an axis. The bracket is shown in dashed lines in FIG. 1B to not obscure the view of the mandrel 150. The bracket 140 may clamp onto the mandrel 150, have a portion inserted into the mandrel 150 or otherwise secure the mandrel 150 in a manner in which the mandrel 150 can be rotated. The mandrel 150 may be made from a variety of materials. Selection of the optimal mandrel material depends on several factors, including the size and weight of the fuel grain, the peak pressure exerted by the inflatable portion 154 of the mandrel 150, and the desired thermal properties. For smaller fuel grains, metallic rods or tubes such as aluminum or steel can provide the necessary rigidity while minimizing weight. Larger fuel grains may benefit from carbon fiber reinforced aluminum rods or tubes, which offer a combination of stiffness and strength to handle the increased loads. The diameter and wall thickness of the mandrel 150 may also be tailored to the specific dimensions of the fuel grain 180. The bracket 140 may include a supporting steady rest 144 which adjusts in height as material is formed on the mandrel 150. The steady rest 144 may be used when the weight of the material deposited on the mandrel 150 is likely to cause the mandrel 150 to defect and sag if not supported. The steady rest 144 may include rollers which adjust with springs or the like as the diameter of the material increases. The steady rest 144 may also include arms which adjust by moving laterally, or alternatively, in a scissor motion. Particularly for large-scale parts, the system may incorporate additional support features such as the steady-rests 144 positioned along the length of the mandrel. These steady-rests 144 provide localized support, preventing flexure due to the weight of the fuel grain, especially during the initial printing stages when uncured material is most susceptible to deformation.

The gantry 130 may dispense a first layer of the melted propellent on the inflatable layer of the mandrel 150 as the mandrel is rotated on the axis. As will be discussed in greater detail below, the first layer may not be directed dispensed on the inflatable layer of the mandrel 150. The dispenser may move the print head 190 as the liquid fuel grain is deposited on the mandrel 150 as the mandrel 150 is rotated such that the fuel material is dispensed in a helical pattern. A second layer of the melted fuel grain may be dispensed on the first layer, with the adjustable gantry raised so the dispenser has sufficient space for the subsequent layer. A second helical pattern of the second layer may be laid down in reverse of the first helical pattern (e.g. left to right rather than right to left with the mandrel still rotating in the same direction) such that the first and second helical patterns do not match. This bidirectional helical pattern may help to reduce the formation of voids that might form if groves in patterns were to match up and the roller was not able to press the propellant into the formed groves. Additionally, by following this pattern the printed bead is continuous and does not have any breaks in it, as when the printer completes one layer and begins to transition from one layer to the next it begins to raise up the print head and then continues back along the opposite direction of the fuel grain. Also, when the layers cool, the different patterns cause there to not be continuous stress lines which can form to cause cracks or delamination. The mandrel 150 may have a shape on an outer surface that acts as a negative for the first helical pattern of the first layer or other complex geometries.

In one embodiment, a support material of dissolvable materials (e.g., polyvinyl alcohol (PVA)) can be printed directly onto the inflatable layer of the mandrel 150 to form complex internal channels or cavities. After the fuel grain has cooled, these dissolvable inserts can be washed away with a solvent, leaving behind the desired port geometry.

In another example embodiment, a support material of soft polymers (e.g., thermoplastic elastomer (TPE)), in conjunction with a non-melting, non-bonding interface layer (e.g., paper), can be printed on the mandrel 150 to create sacrificial layers that define the fuel grain's internal port geometry. Embedded pull strings or dissolvable support structures within the soft polymer layer facilitate its clean removal after the fuel grain has cured. The paper or similar non-bonding layer prevents the fuel material from adhering to the support structure, enhancing separation. It may remain embedded in the grain, potentially acting as an ignition enhancer if composed of a high-burning temperature material. Dissolvable inserts can be used to create complex channels or cavities within the fuel grain, while sacrificial layers can define the overall port geometry. The sacrificial layer can then be easily removed, leaving behind the dissolvable insert, which is subsequently dissolved with a solvent.

The thermal control unit 160 may be configured to heat the chamber using, the environment heater 162, to a desired temperature. The thermal control unit 160 may heat the chamber to a temperature just below (about 2 degrees Celsius) the crystallization temperature of the fuel grain. In this way the fuel grain cools evenly after dispensing and does not crack from unevenly reducing thermal expansion of the material. The thermal control unit 160 may gradually reduce the temperature of the chamber during final cooling after all the layers of the propulsion fuel are deposited and crystalized. The thermal control unit 160 may include a thermometer or other type of sensor to provide feedback to the heater. The thermal control unit 160 may provide localized temperature control within the build chamber using infrared lamps 164 which may be pointed at specific locations such as the mandrel 150 to keep the mandrel and any propellant deposited on the mandrel 150 by the print head 190 at a desired temperature. The thermal control unit 160 may include radiant heaters to provide zone-based temperature control, ensuring each material (fuel, thermosets, high-temperature thermoplastics) receives optimal thermal input during processing. The thermal control unit 160 may also include targeted heating elements such as the infrared lamps 164 or other elements which provide even more precise temperature control within specific zones. The thermal control unit 160 may also include thermal control over the mandrel 150 through active thermal control fluids such as oil or refrigerant so as to maintain high temperature during printing and then actively cooler temperatures during cooldown so as to be the primary method of cooling after part completion.

The controller 170 may control all of the other elements of the additive lathe 100. For example, the controller may control the chamber 110 (including the ventilation and sealing of the chamber 110), the plurality of feed lines 120, the gantry 130 (including movement of the adjustable arm 132 and print head 190), the bracket 140, and the thermal control unit 160. The controller 170 may be connected to each of the elements and provide control signals for controlling each of the elements. The controller 170 may include a processor and memory including instructions for controlling the additive lathe 100. The controller 170 may also include an input terminal for receiving inputs and commands from an operator. The controller 170 may be used in active print monitoring and closed loop feedback control to predict and avoid print failures and improve production time. Active print monitoring may be used to take in a raw model and then dynamically produce the part. The controller 170 can use active monitoring to adjust printing speed, layer height, polymer temperature before and after layer deposition, steady rests to support large scale parts and actively measure part shrinkage.

The manner in which the mandrel 150 rotates and the print head 190 dispenses the melted propellent allows the AM process to take advantage of the CTE properties of the polymer to cause the polymer to constrict while cooling such that voids are not formed and the fuel grain has an isotropic nature. Further, the 3D helical pattern allows for more of the material to be placed on each layer compared to a 2D layer printed with cartesian 3D printing. This reduces manufacture time significantly by reducing the cooling time. The mandrel 150 allows the cooling time to be significantly reduced by maintaining a uniform temperature due to the hottest layer surrounding the mandrel 150. The mandrel 150 may be internally heated and/or cooled to maintain a homogeneous temperature across the mandrel 150 and in the material deposited on the mandrel as the material is formed on the mandrel. In one embodiment, the mandrel may be used to cool the fuel grain 180 from the inside out by actively cooling the mandrel 150 while applying heat to the exterior of the outer insulating layer 186 and fuel grain 180 using the environment heater 162 and infrared lamps 164. In this way the interior layers of the fuel grain 180 solidify and shrink in size before the exterior layers to prevent cracking.

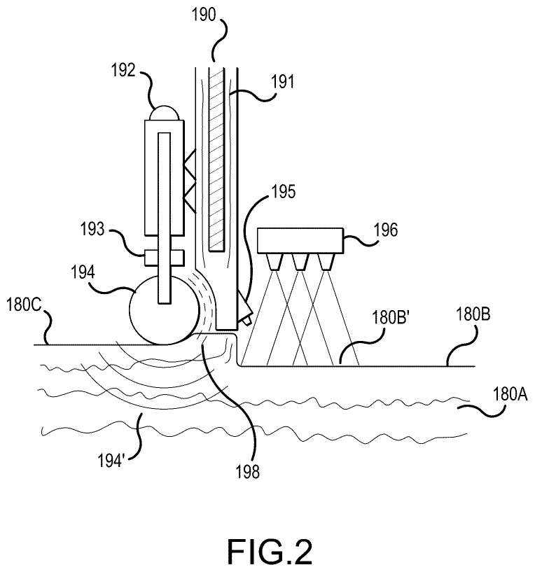

FIG. 2 shows a first embodiment of the print head 190 depositing a polymer bead according to an example embodiment. The print head 190 may include an extruder 191, a linear actuator 192, a load cell 193, a roller 194, a pyrometer 195, a laser array 196, and a gas ejector 198. The extruder 191 may contain an extruder screw or other mechanisms allowing for the propellent feedstock to be extruded. The extruder 191 may extrude a mixture of polymer, oxidizer, metal, and any other materials included in the fuel grain to form a fuel grain layer. The extruder 191 may be inductively, resistively, or fluidically heated. The extruder 191 may provide the fuel grain in the form of bead deposition. The linear actuator 192 may move the roller 194 into contact with the extruded material. The load cell 193 may measure a force applied by the roller 194 to provide feedback for control of the linear actuator 192. The roller 194 may apply pressure to the extruded material to form the fuel grain layer (in the example shown in FIG. 2, a third layer 180C is formed on a second layer 180B and first layer 180A). The roller 194 may be thermally controlled such that when compressed the fuel material creates a ‘shell’ over the surface of the bead to hold the material in place. The roller 194 may apply an ultrasonic vibration 194′ to the fuel grain to cause the polymer chains to mix while in a molten state to fuse the fuel grain layers 180C and 180B together. The ultrasonic vibration at the roller 194 may be caused by an ultrasonic transducer in the linear actuator 192. The gas ejector 198 may create an air skirt around the area where the melted polymer is deposited from the extruder 191. The air skirt may provide thermal control to maintain a local temperature around an extruder nozzle to maintain the polymer in a liquid form as it is compressed by the roller. The air skirt may also control oxygen levels around the extruder nozzle by providing a gas, such as a nitrogen, without any oxygen or with reduced oxygen levels. The gas ejector 198 may include a compressor, a compressed gas tank, a heater/cooler, and a control valve to control the pressure and temperature of the gas ejected from the gas ejector 198.

The laser array 196 may be pointed at the uppermost layer of the fuel grain (second layer 180B in this example) and may emit lasers with sufficient power to melt the top of the outermost complete layer of the fuel grain, the melted outermost completed layer of the fuel grain is shown by 180B′ in FIG. 2. The pyrometer 195 measures the temperature of the outermost completed layer of the fuel grain to ensure that the temperature is above the melting point of the polymer before the new layer is deposited on the outermost completed layer of the fuel grain. The combination of melting the outermost completed layer before the new layer is deposited, depositing the new layer with polymer in a liquid form, pressing the deposited liquid polymer in the new layer, and ultrasonically vibrating the new layer, causes the polymer chains of the outermost complete layer and the polymer chains of the new layer to mix and fuse. This prevents delamination, void formation, and cracking between the layers. This system can eliminate delamination between layers by creating an isotropic part that maintains a consistent and homogeneous material properties all throughout the fuel grain by molecularly fusing each layer together instead of placing a new layer on top of a previous layer depending on heat transfer from the new layer to the previous layer to melt the surface enough to get the layers to stick together. This process also removes voids and improves the density of the fuel grain by mitigating shrinkage and porosity within each layer. Achieving complete material density that approaches theoretical limits, along with an isotropic material structure, improves predictability of combustion and consistent mechanical behavior. This combined with the ability to change the composition of each layer provides the advantage of the creation of tailored burn profiles previously unattainable.

The mandrel 150 in conjunction with the in-situ compounding capabilities described related to the plurality of feed lines 120, enable the creation of fuel grains with advanced internal layering and composition control. For example, layers with ignitability enhancements may be created. Oxidizer doping or incorporation of hypergolic solids near the head end or core of the fuel grain where combustion initiates, tailored through in-situ compounding, can significantly improve ignition reliability, and reduce startup transients. The in-situ compounding system can introduce performance-enhancing additives or tailored material compositions at specific locations within the grain during the build process. This creates discrete zones with distinct properties, optimizing burn characteristics, internal port protection, or other performance metrics. Also, the ability to create an integrated ablative insulator, directly on the outer diameter of the fuel grain provides essential thermal protection for the rocket motor casing and allows for more integrated manufacture of the fuel for the rocket. These integrated advancements in additive manufacturing, in-situ compounding, and mandrel-based construction techniques redefine the production landscape for hybrid rocket fuel grains. These improvements address long-standing limitations of traditional methods by enabling the consistent creation of high-performance, geometrically complex grains with unprecedented control over material composition and properties.

In some embodiments the roller 194 may be replaced by a tamper which the actuator 192 moves up and down with relation to the top surface of the fuel grain 180 to press down the deposited fuel material.

A dedicated thermoset mixing extruder may be included in the print head 190. The thermoset mixing extruder may include snap-curing capabilities (e.g., UV exposure), enables the integrated creation of thermoset resin liners or other structures.

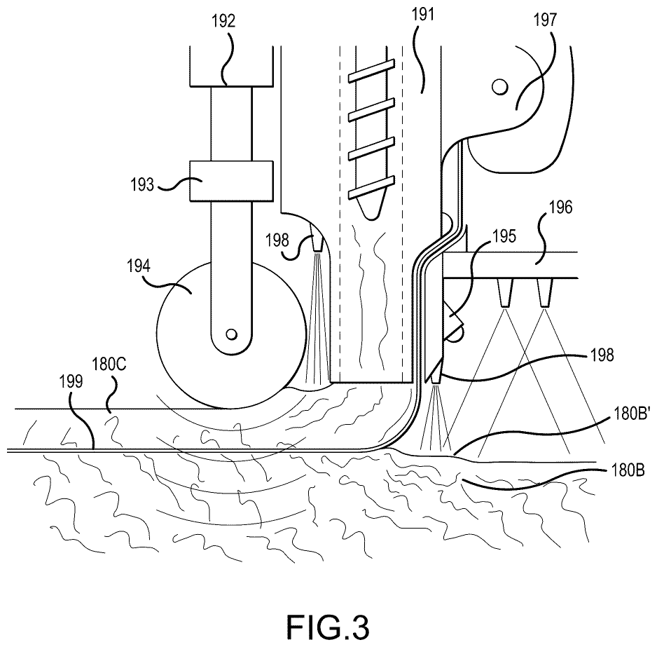

FIG. 3 shows a second embodiment of the print head 190 depositing the fuel grain with a fiber reinforcement according to an example embodiment. The print head 190 may include a fiber feeder 197 which lays down a continuous fiber material 199 onto the melted uppermost completed layer 180B'. The melted new layer 180C is then deposited on the fiber material 199. The ultrasonic vibration causes the molecular chains of the melted polymer to intertwine with the fiber material 199 creating a strong bond. The fiber material may be composed of, but not limited to cross-linked polyethylene fiber, glass fiber, Kevlar fiber, Nylon fiber, or carbon fiber and may increase structural integrity of the fuel grain 180. Cross-linked polyethylene fiber may be used to bind fuel layers. The crosslinked polyethylene has the benefits that it is a fuel material that will also help prevent cracking, other polymeric fibers like nylon can also achieve this. Glass fibers and carbon fibers may be used for placing a polyether ether ketone (PEEK), poly-ether-ketone-ketone (PEKK), or polyetherimide (PEI) outer insulating layer 186 on the fuel grain 180. The PEEK, PEKK, or PEI insulating layer may be used as an insulator so burning of the outermost layer of the fuel grain 180 does not damage the rocket the fuel grain 180 is propelling. Layers of insulators and/or wound filament may be added after the fuel grain 180 is formed to provide the desired insulation for the manufactured fuel grain. An insulator, composed of high-temperature polymers such as PEEK or PEI potentially reinforced with fibers or ceramics, prevents excessive heat transfer to the casing and reduces the need for additional thermal shielding. An intumescent polymer or flame-resistant material may be printed on the outer surface of the fuel grain to act as an insulative liner. An injector and nozzle may be attached to either end of the fuel grain 180 before wrapping to complete the assembly of fuel for a rocket.

The robust design of the mandrel, essential for withstanding the forces of fuel shrinkage, also makes it an ideal platform for incorporating a filament winding head. This integration empowers the creation of a complete hybrid rocket motor assembly within a single machine. The filament winding process involves precisely wrapping continuous strands of reinforcing fibers (such as carbon fiber, glass fiber, or other high-performance fibers) around the mandrel 150 and/or layers of fuel grain, building up layers of material pre-impregnated with a thermoset or thermoplastic resin matrix. This technique significantly enhances the structural integrity and hoop strength of the fuel grain, allowing it to withstand high combustion pressures without compromising performance. Furthermore, it enables the fabrication of the rocket motor casing directly onto the fuel grain outer diameter, creating a monolithic structure that maximizes weight efficiency and eliminates the need for complex bonding interfaces. The integration of filament winding and additive manufacturing technologies creates an all-in-one system that reduces manual production steps, enhances precision, and maximizes the performance and efficiency of hybrid rocket motors.

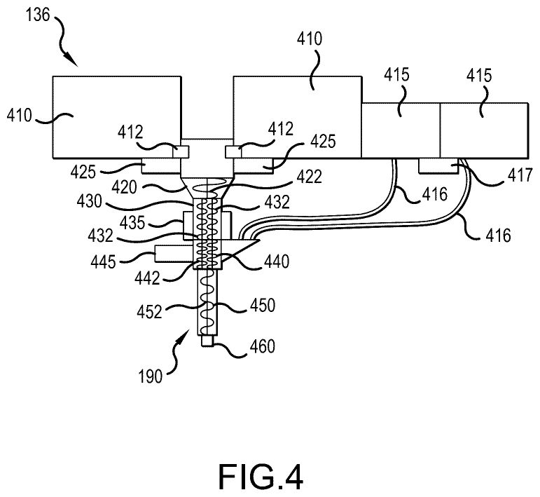

FIG. 4 is a cut away showing the inside of the print head 190 and second hoppers 136 according to an example embodiment. The print head may have an outer casing of metal or other durable material. The print head 190 may be separated into several segments which are enclosed sections of the print head 190 that communicate with each other internally. The second hoppers 136 may include binder hoppers 410 including dispensers 412 and additive hoppers 415. The print head 190 may include a receiver 420 including an auger (or agitation screw) 422, a heating segment 430 including at least one heater 435 and one or more extruders 432, a mixing segment 440 including at least one mixer 442 and an air control system 445, a pumping segment 450 including at least one extruder, and a nozzle 460. Not shown in the image are a plurality of motors which cause the movement of the dispensers 412, the auger 422, the extruders 432, the mixer 442, the extruder 452 and nozzle 460. The motors are controlled by the controller 170. The print head 190 including the barrel and screws are constructed from high-strength, corrosion-resistant steel alloy, such as hardened stainless steel (e.g., 4140 or D2 tool steel), to withstand high pressures, temperatures, and abrasive wear from additives. The interior barrel surfaces and screw flights are surface-hardened and polished to minimize friction, prevent material sticking, and facilitate cleaning.

The binder hoppers 410 may be containers which include pellets of binders that are fuel for the rocket. For example, the binders may be any of HDPE, paraffin wax, POM, epoxy resin, melamine, PET (polyethylene terephthalate), HTPB (hydroxyl-terminated polybutadiene), GAP (glycidyl azide polymer), BAMM (butyl acrylate-methyl acrylate), PGN (polyclycidyl nitrate), PLN (polymeric lipid hybrid nanoparticles), MDI (methylene diphenyl diisocyanate), and IDP (inherently dissipative polymers). A combination of polymers such as the co-polymers combination of acrylonitrile, butadiene, and styrene may be used as well. The binder hoppers 410 may each include a dispenser 412. The dispenser 412 may dispense the binder polymer pellets into the receiver 420.

The receiver 420 may be an enclosed chamber of the print head 190 which is configured to receive the binder pellets dispersed from the binder hoppers 410 and convey the binder pellets using the auger 422 to the heating segment 430. The auger 422 may be made of stainless steel and driven by a geared connection to a main extruder screw drive, to gently agitate the polymer material and ensure consistent flow into an extruder inlet leading to the heating segment 430, preventing bridging or rat-holing, especially with powders or irregularly shaped pellets. The receiver 420 may also include a vacuum pump 425 configured to remove all air from the receiver 420 to prevent air bubbles from forming as the binder pellets melt in the heating segment. Other vacuum pumps may also be used where needed to prevent the formation of air bubbles. For example, a vacuum pump may be included to remove air from the mixing segment 440.

The heating segment 430 may be an enclosed chamber of the print head 190 which is configured to be in vacuum and the heater 435 heats the heating segment to cause the binder pellets to melt. The heater 435 may be an electrical heater such as an inductive heater that heats the extruders 432 using induction or a resistance type heater heating the extruders using conduction of heat generated from resistance to electric current. Heat sensors may be used to provide feedback to ensure the proper temperature for melting the binder polymer and also ensuring that a dangerously high temperature that might cause combustion is not reached. An induction heating system may be controlled by a closed-loop feedback system using thermocouples embedded within the extruder barrel. A programmable logic controller (PLC) or dedicated temperature controller regulates the power output to the induction heating coils based on temperature feedback, ensuring precise and stable temperature maintenance within each heating zone. Induction heating allows for highly precise and responsive temperature control, for maintaining optimal melt temperatures and preventing polymer degradation, especially when processing thermally sensitive polymers or those containing volatile additives. The extruders 432 may be counter rotating screws (e.g., two screws rotating in opposite directions) or a planetary gear or other similar hardware which can transfer heat to the binder pellets to melt the binder pellets. The extruders may also compress the binder pellets down through rotating to form a voidless liquid. The liquid binder polymer may be pushed into the mixing segment 440 by the extruder 432 through an opening communicating between the heating segment 430 and the mixing segment 440.

The mixing segment 440 may be an enclosed chamber of the print head 190 which includes a mixer 442 which mixes the liquid binder with additives. The mixer 442 may include one or more screws. The mixer 442 may include one or more dynamic mixers. A dynamic mixer includes a moving part attached to a screw. The mixing segment includes a vacuum mixing chamber, integrated directly within the extruder barrel and maintained under a hard vacuum, it is the location where final degassing and in-situ mixing of additives with the polymer melt occurs. By performing mixing under vacuum, the system effectively minimizes porosity and enhances material homogeneity, especially when incorporating solid additives. Additives may be transferred to the mixing segment from the additive hoppers 415 via conveyers 416 leading to additive ports in the mixing segment 440. The introduction of material to the conveyers 416 is controlled by actuators (not shown) which control an opening into the conveyers. Thus, the mixing segment may be configured to receive the liquid binder polymer and the additives. The additive ports allow for the precise and controlled introduction of various additives-solid powders, chopped fibers, or liquid agents-directly into the polymer melt during the extrusion process. The strategic location of these ports within the vacuum mixing chamber ensures efficient and immediate mixing of the additives under vacuum conditions. The additive ports may be strategically positioned along the vacuum mixing chamber in the upper section of the barrel to allow gravity-assisted feeding of solid additives. Multiple ports (e.g., 2-4 ports) can be incorporated to allow for sequential or simultaneous introduction of different additives. Ports can be designed for powder feed (e.g., metal powder, oxidizer powder, and pigments), chopped fiber (conveyed using pneumatic or vibratory feeders), and liquid injection (e.g., plasticizers and catalysts injected using precision pumps). Additive ports may be equipped with vacuum seals and valves to maintain vacuum integrity within the mixing chamber during additive introduction and prevent backflow. Additive feed rates may be precisely controlled by the system PLC, allowing for dynamic adjustment of material composition during the extrusion process.

The conveyers 416 may include gravity fed tubes, or other hardware which can operate under vacuum to convey the additives to the vacuum mixing chamber, maintained at a hard vacuum (e.g., <1 kPa absolute pressure), continuously evacuated by a high-vacuum pump connected to the vacuum manifold. Vacuum level may be monitored by a vacuum sensor and controlled by the PLC. Length and diameter of the mixing chamber are optimized based on polymer viscosity, additive type and loading, and desired mixing intensity and residence time. The mixing segment and mixing chamber may be constructed from the same high-strength steel alloy as the extruder barrel, with smooth, polished interior surfaces to facilitate material flow and cleaning. The mixing segment may have sealed connections to the extruder barrel and additive introduction ports ensure vacuum integrity within the mixing chamber.

The additives may be prepared for mixing in the conveyer 416 by being heated by a heater (not shown) or otherwise conditioned. The conveyer 416 may have dispensers similar to the dispensers 412 of the binder hoppers 410 or similar devices to take the additives from the additive hoppers 415. The conveyer 416 may deposit the additives into the mixing segment so the mixer 442 can combine the liquid binder polymer with the additive. The binder hoppers 412 and additive hoppers 415 may be maintained under a soft vacuum using vacuum pumps 417 and 425 (e.g., 5-10 kPa absolute pressure) by a vacuum pump connected to a vacuum manifold. This soft vacuum helps to pre-degas the bulk feedstock and reduce initial air and volatile content entering the system. The conveyers may cause the additives to be added at different locations such as different heights. For example, the oxidizer may be added first above the location where the metal is added. The mixer may include two or more screws, an agitator, a pineapple, or another form of mixing hardware. The mixer may utilize intermeshing co-and counter-rotating screws arranged in a twin-screw configuration. The co-rotating sections promote forward material conveying and initial mixing, while the counter-rotating sections induce elongational flow and high shear, enhancing distributive and dispersive mixing. The screws are equipped with enhanced surface area mixing elements, such as pineapple mixing sections, Dulmage mixing sections, Maddock mixing sections, pin mixing sections, Saxon mixing sections, or combinations thereof. Alternatively, a Barrier screw or mixer which is characterized by its segmented, radially offset elements that create a high-surface-area and complex flow path may be sued for enhanced mixing. These mixers may be used to maximize the contact area between the polymer melt and additives to promote efficient mixing, create complex flow patterns and high shear rates to effectively disperse and distribute additives throughout the polymer matrix, and minimize material stagnation and buildup within the mixing chamber, facilitating efficient material transport and cleaning. The mixer 442 may be directly driven by the main extruder drive motor through a gearbox and coupling system, ensuring synchronized operation with the main extruder screws. Screw speed and rotation direction can be controlled by the PLC to optimize mixing intensity and residence time. The mixer 442 may be constructed from hardened steel alloys, compatible with the polymers and additives being processed, and surface-treated for wear resistance and ease of cleaning.

The air control system 445 may include a vacuum pump and/or air pump. The vacuum pump may be used to ensure that the mixing is performed in vacuum and that the addition of the additives does not introduce air to the mixture. Maintained under a harder vacuum (e.g., &lt; 1 kPa absolute pressure), typically achieved by a dedicated high-vacuum pump stage connected to the vacuum manifold. The air pump may be used to create a foam with air purposefully added to the mixture. The foam can be used for insulating layers, less dense layers, or other applications where a mixture including air is desired. In specific applications, such as fabricating fuel grains requiring thermal insulation for the motor casing, it may be desirable to intentionally introduce a controlled amount of air or inert gas into the vacuum mixing chamber. For example, air and burn inhibiting additives, such as borax, glass fiber, and carbon fiber may be added to the polymer in the mixing segment 440 such that an insulating foam can be extruded from the nozzle. Instead of maintaining a high vacuum, a precisely controlled leak or gas injection system can be activated to introduce a metered flow of air (or inert gas like nitrogen or argon) into the vacuum mixing chamber during the mixing process. The controlled gas introduction serves to induce void formation, create form structure, and tailor insulation properties. The introduced gas becomes entrapped within the viscous polymer melt during mixing, creating a multitude of micro-voids throughout the material matrix. The resulting material solidifies into a foam-like structure with significantly reduced density and thermal conductivity compared to the fully dense polymer. The volume fraction of voids, and thus the insulation performance of the foam layer, can be controlled by adjusting the rate of gas introduction, mixing parameters, and polymer properties. By selectively introducing air during the printing of the outer layers of a hybrid or solid rocket fuel grain, a low-density, thermally insulating foam layer can be directly additively manufactured onto the fuel grain's exterior surface. This integral foam layer can serve as a thermal barrier to protect the motor casing from excessive heat flux during combustion, simplifying motor design and improving thermal management. This is particularly advantageous when using high chamber temperature propellants or lightweight casings with limited heat tolerance. In this mode of operation, the “vacuum mixing chamber” effectively becomes a “controlled atmosphere mixing chamber,” allowing for both vacuum degassing and controlled gas entrainment depending on the desired material properties for different sections of the printed part.

To ensure effective degassing of the polymer feedstock and consistent material delivery to the extruder, a multi-stage vacuum hopper system may be employed. This system minimizes porosity in the final additively manufactured parts. Instead of relying on a single vacuum hopper, a two-stage approach is utilized, comprising a primary hopper stage for bulk feedstock pre-degassing and a secondary vacuum hopper stage for enhanced degassing and consistent feeding into the extruder. This multi-stage design maximizes degassing efficiency by subjecting the polymer material to vacuum at different stages and levels, effectively removing both surface-bound air and entrapped volatiles before the material enters the vacuum mixing chamber within the extruder barrel. The system is interconnected by a rotary metering valves (dispensers 412) that further contributes to degassing through a vacuum purge port. The dispensers 412 provide accurate volumetric metering of the polymer feedstock from the primary hopper to the secondary vacuum hopper. The dispensers 412 may also incorporate a vacuum purge port, adding another stage of degassing to the polymer material just before it enters the extruder. Each chamber of the dispenser 412 may be precisely sized to meter a consistent volume of material with each rotation. As a chamber rotates towards the discharge position into the secondary hopper, it may pass over a vacuum purge port. This port is connected to the high-vacuum manifold and applies a hard vacuum directly to the metered material within the chamber for a brief period. This vacuum purge further degasses the polymer material just before it enters the extruder, maximizing degassing efficiency and removing surface-bound volatiles. The chamber then rotates to the discharge position, releasing the metered and purged polymer material into the secondary vacuum hopper. The volumetric feed rate is controlled by adjusting the rotational speed of the valve, which can be precisely controlled by a servo motor and control system. For blending multiple polymers, multiple primary hoppers and rotary valves can be used, with their rotation speeds and phasing adjusted to achieve the desired mixing ratios. The dispensers 412 may be constructed from materials compatible with the polymers being processed, such as hardened steel or engineered polymers with low outgassing characteristics suitable for vacuum environments. Seals may be used to maintain vacuum integrity and prevent leakage. The dispensers 412 may be driven by a precision servo motor with feedback control, enabling accurate and repeatable volumetric metering. The valve rotation speed is controlled by the main system PLC, enabling dynamic adjustment of feed rates and polymer blend ratios.

The mixer may pass the mixed binder and additive to the pumping segment 450. The pumping segment 450, may include at least one extruder 452 which is a screw or other similar hardware to convey the mixed liquid binder and additives to the nozzle 460. The pumping segment 450 may ensure a consistent and pulse-free flow of the homogenized polymer-additive melt to the extrusion nozzle is crucial for achieving uniform layer deposition and part quality in additive manufacturing. The spiral melt flow pump may be incorporated downstream of the vacuum mixing chamber to fulfill this function. This positive displacement pump isolates the mixing and extrusion processes from pressure fluctuations at the nozzle, guaranteeing a stable and predictable material flow rate. A spiral screw or gear pump mechanism is employed as the extruder 452 to generate positive pressure and ensure consistent, pulse-free flow of the homogenized polymer-additive melt to the extrusion nozzle. A spiral screw pump is preferred for its simplicity and effectiveness in conveying viscous polymer melts. The melt flow pump may isolate the mixing chamber from pressure fluctuations at the nozzle and ensure a stable and predictable material flow rate, crucial for consistent layer deposition in additive manufacturing. The extruder 452 may be driven by the main extruder drive motor through a gearbox, synchronized with the agitator and main extruder screws.

The pumping segment 450 may be configured to receive the mixture and extrude the mixture through the nozzle 460. The nozzle 460 may have an adjustable opening which allows the controller 170 to control the amount and dimensions (width and thickness and angle) of the extruded mixture. The nozzle 460 may be adjusted in width, thickness, and angle using actuators 462 which may rotate the aperture in the same plain as a screw axis of the extruder 432 and change the dimensions of the aperture. To enhance the versatility and precision of the additive manufacturing process, a dynamic nozzle aperture may be integrated into an extrusion head. This feature allows for real-time adjustment of the nozzle opening dimensions during printing, enabling adaptive control of bead width and material flow rate. This dynamic control is particularly beneficial for optimizing print resolution, material deposition, and adapting to complex part geometries. This mechanism allows for real-time adjustment of the nozzle opening dimensions (width and/or height of the slot) during the printing process. Aperture adjustment is achieved using a servo-controlled or pneumatically actuated mechanism. For example, two sliding nozzle plates forming the slot aperture can be precisely positioned by linear actuators driven by servo motors. The nozzle aperture is dynamically controlled by the system PLC, based on feedback from part geometry data, layer thickness settings, and potentially real-time flow rate sensors. The bead width may be adjusted based on part contour and infill patterns to optimize print resolution and material deposition rate. The flow rate may be modulated by adjusting the nozzle aperture, in addition to screw speed control, for precise material delivery. Also, real-time compensation for material viscosity variations or changes in printing parameters may be made. The nozzle 460 may be constructed from wear-resistant materials, such as hardened steel or ceramic inserts, to withstand polymer melt flow and potential abrasive additives. Thermal control elements may be integrated into the nozzle to maintain melt temperature and prevent drooling.

Additional thermal controls, such as cooling channels in the casing of the mixing section, may be used to control the temperature in the various segments of the print head 190. The temperature may be lowered to improve safety while adding oxidizer to the mixture. The print head 190 may be used to print fuel grains, and other similar polymer-based products. Also, dynamically tailored compositions and properties for diverse applications may be made, including chemical processing, pharmaceuticals, and specialized construction materials. The print head can be used for standard cartesian 3D printing, or any other form of additive manufacturing.

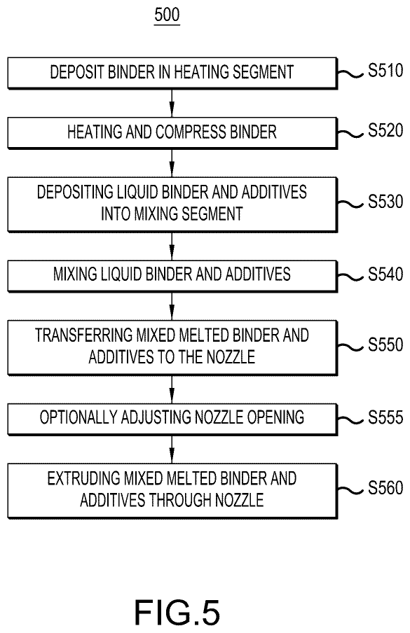

FIG. 5 is a flow chart of action taken by the second hoppers 136 and print head 190 according to an example embodiment. At S510, the binder hoppers 410 deposit the binder (binder pellets) in the receiver 420 which are then conveyed to the heating segment. At S520, the heating segment 430 using the heater 435 and extruder 432 heats and compresses the binder into a voidless liquid. At S530, the heating segment 430 using the extruder 432 deposits the liquid binder into the mixing segment 440 and the conveyer 416 deposits additive to the mixing segment 440. At S440, the liquid binder and the additives are mixed together to form a mixture of the liquid binder and the additives. At S550, the mixture of mixed liquid binder and additives is transferred to the pumping segment 450 by the mixer 442. At S555, the nozzle 460 is optionally adjusted, in location and size for dispersal of the mixture if any adjustments are needed. At S560, the mixture of mixed liquid binder and additives is extruded through the nozzle 460 while the controller controls movement of the mandrel 150 and the gantry 130 so that the mixture is extruded in a programmed pattern.

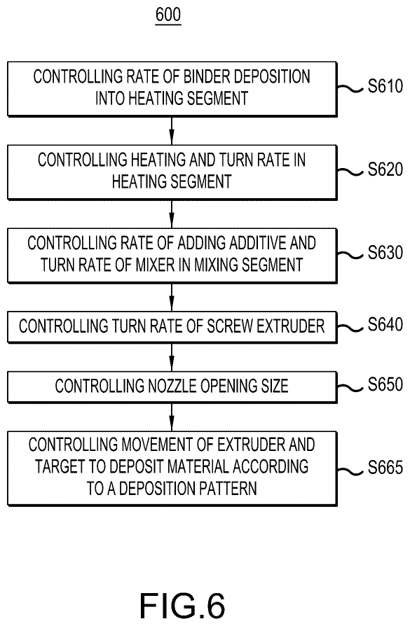

FIG. 6 is a flow chart showing controls by the controller 170 according to an example embodiment. At S610, the controller 170 may control the rate the binder is deposited into the heating segment 430 by controlling the dispensers 412 and the auger 422. Each binder hopper 410 may include a different binder polymer. The controller 170 may control the rate that each polymer is deposited into the receiver 420 by changing a rotation rate of the dispenser 412 of each binder hopper 410. A polymer may be considered an additive which may change in concentration in the produced fuel grain to change burn characteristics of the fuel grain. At S620, the controller 170 may control the heat provided by the heater 435 and turn rate of the extruder 432 in the heating segment 430 to form the voidless liquid binder and convey the voidless liquid binder to the mixing segment. The controller 170 may also receive feedback from temperature sensors and be configured to control the heater 435 to maintain a temperature between a melting temperature of the binder polymer and a combustion temperature of the binder polymer mixed with the oxidizer. At S630, the controller 170 may control the rate that additive is added to the mixing segment by controlling dispensers for the additive hoppers 412. For example, the controller 170 may control an amount of oxidizer and metal added to the liquid binder. The amount of each additive may be controlled separately and may be changed over time or over volume of the liquid binder passed through the mixing segment. In this way the controller 170 may control the amount of additive included in the mixture dispersed by the nozzle and the composition of the fuel grain produced by the additive lathe 100. At S650, the controller 170 may control the shape of the nozzle to control the volume, width, and thickness of the extruded mixture. At S655, the controller 170 may control the movement of the gantry 130 and mandrel 150 while the mixture is extruded to form a programmed pattern.

The system may operate as a closed-loop controlled unit, with all subsystems communicating and synchronizing through a central Programmable Logic Controller (PLC) or a dedicated industrial-grade real-time control system. The multi-screw extrusion system is designed for seamless integration into a multi-axis additive manufacturing platform, enabling automated fabrication of complex 3D parts. The system's operation is governed by a hierarchical control architecture ensuring coordinated and precise control of all subsystems. The controller 170 controls material handling and feeding by controlling of the primary and secondary vacuum hopper system, rotary metering valve operation (speed, phasing for multi-polymer blending), and agitation screw drive. The controller 170 controls extrusion and heating by regulating the induction heating system (temperature zoning, power output), extruder screw drive (speed, torque), and spiral melt flow pump drive. The controller 170 controls the vacuum system by controlling vacuum pumps for primary and secondary hoppers and the vacuum mixing chamber, monitoring and maintaining desired vacuum levels. The controller 170 controls additive introduction by controlling additive feeders (volumetric, screw, pneumatic, liquid pumps) for precise and dynamically adjustable additive flow rates into the vacuum mixing chamber. The controller 170 controls the dynamic nozzle aperture by controlling nozzle aperture actuation system (servo-pneumatic), adjusting nozzle dimensions in real-time based on printing parameters. The controller 170 controls a sensor network by acquiring and processing data from a comprehensive network of sensors throughout the system. The controller 170 controls a safety interlock by implementing safety interlocks and emergency stop mechanisms to ensure safe operation, particularly when handling energetic materials. A comprehensive network of sensors may be integrated throughout the system to provide real-time feedback for precise process control and monitoring. Temperature Sensors (Thermocouples, RTDs) may be embedded within each heating zone of the extruder barrel (feed zone, melting zone, vacuum mixing chamber, pumping zone, nozzle) to monitor and control temperature profiles. Pressure Sensors may be located at points in the extruder barrel (e.g., melt zone, mixing chamber, pump outlet, nozzle inlet) to monitor material pressure and detect potential blockages or pressure fluctuations. Vacuum Sensors (Pirani, Capacitance Manometers) are integrated into the primary hopper, secondary vacuum hopper, and vacuum mixing chamber to precisely measure and maintain desired vacuum levels. Flow Rate Sensors (Volumetric, Mass Flow Meters) may be incorporated at the rotary metering valve and/or melt pump outlet to directly measure and control polymer and additive flow rates. Position Sensors (Encoders, Linear Transducers) may be used for feedback control of the rotary metering valve position, screw rotation speed, and dynamic nozzle aperture position. Load Cells/Torque Sensors may be integrated with the extruder screw drive to monitor motor load and detect material viscosity changes or potential processing issues.

System operation may be managed through a user-friendly software interface, typically implemented on a dedicated industrial PC or workstation. The software may provide functionalities for process parameter setting that defines and adjusts all key process parameters, including temperature profiles for each heating zone, vacuum levels, screw speeds, feed rates for polymers and additives, nozzle aperture settings, and AM build parameters. Real-time monitoring may be used to display real-time data from all sensors (temperature, pressure, vacuum, flow rates, etc.) in graphical and numerical formats for process visualization and monitoring. Recipe Management may be used to create, save, and load process recipes for different materials and part geometries, ensuring process repeatability and consistency. Data logging and analysis may be used to record process data for quality control, process optimization, and traceability. Alarm and fault handling may be implemented in alarm systems to alert operators to process deviations or faults, and automated fault handling routines to ensure safe system shutdown in case of critical errors. Remote control and monitoring may enable remote operation and monitoring of the system via network connectivity.

The system may offer a wide range of adjustable operational parameters to optimize material processing and part fabrication. Temperature profiles may be independently controllable for temperature setpoints for each heating zone of the extruder barrel (feed, melt, mixing, pump, nozzle) to tailor the thermal history of the polymer melt. Vacuum levels may be adjustable for the primary hopper, secondary vacuum hopper, and vacuum mixing chamber to optimize degassing efficiency and minimize porosity. Screw Speeds may be independently controllable for the main extruder screws and the mixing agitator screws to adjust shear rate, mixing intensity, and material residence time. Feed rates may be precisely controlled for polymer and additive feed rates via the rotary metering valve and additive feeders, enabling dynamic composition control and gradient material structures. Nozzle aperture may be dynamically adjustable for nozzle opening dimensions to control bead width and material deposition rate during printing. Mixing ratios may be controlled for multi-polymer blends and composite materials, precise control over the mixing ratios of different polymers and additives through the rotary metering valve and additive feeders. The typical operational workflow involves material loading (loading polymer pellets and powdered additives into their respective hoppers), recipe selection (selecting a pre-defined process recipe or defining new process parameters via the user interface), system start-up and vacuum generation (initiating the vacuum pumps to establish desired vacuum levels in the hopper system and mixing chamber and activating the induction heating system to preheat the extruder barrel), material feeding and extrusion (starting the extruder screw drives and rotary metering valve to initiate polymer feeding and melting and activating additive feeders to introduce additives into the vacuum mixing chamber at the specified rates, additive mixing and degassing (material is conveyed through the vacuum mixing chamber where additives are thoroughly mixed and the mixture is degassed), melt pumping and nozzle extrusion (the spiral melt pump ensures consistent material flow to the dynamic nozzle, where the material is extruded to build the 3D part layer by layer under AM platform control), real-time process monitoring and control (throughout the process, the PLC continuously monitors sensor data and adjusts process parameters (temperature, vacuum, screw speeds, feed rates, nozzle aperture) to maintain stable and optimal processing conditions), and system shutdown and purging: (upon completion of the printing process, the system is automatically shut down, heating and drives are deactivated, and a purging cycle may be initiated to clear the extruder barrel of residual material).

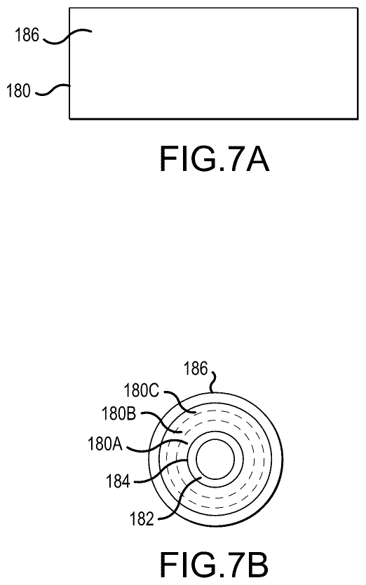

FIG. 7A is a side view of the fuel grain 180 with the outer insulating layer 186 according to an example embodiment. The fuel grain 180 has a general cylindrical shape. The helical pattern in which the fuel grain 180 and the outer insulating layer 186 are deposited may not be noticeable because of the milling process performed on the fuel grain 180 and outer insulating layer 186.

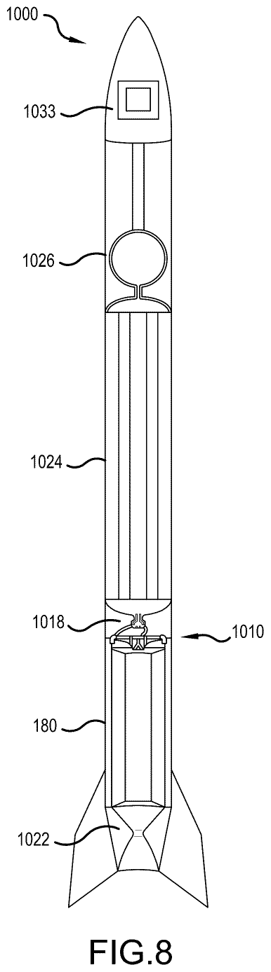

FIG. 7B is a bottom view of the fuel grain 180 according to an example embodiment. The fuel grain 180 is shown with three layers (180A-C). However, the fuel grain 180 may have any number of layers. The layers 180A-C are shown with dashed lines because the manufacturing process causes the layers to form into an isotropic fuel grain 180 where the layers are not distinct. The fuel grain 180 as shown in FIG. 8B also has the support material 182, insulating layer 184, and outer insulating layer 186. The insulating layer 184 and support material 182 are in the central port of the fuel grain 180 and may be removed before the fuel grain is used as a propellant in a rocket. The outer insulating layer 186 is formed on the exterior of the fuel grain 180 and is not removed before the fuel grain is used as a propellant in a rocket. The fuel grain may comprise a binding polymer, a metal, and a solid oxidizer. The fuel grain may have a hollow cylinder shape with an opening passing completely through a center of the fuel grain, the metal and the solid oxidizer are mixed into the binding polymer. A concentration of the solid oxidizer in the fuel grain is greatest at an interior surface of the fuel grain in the opening in the center of the fuel grain. The concentration of the solid oxidizer in the fuel grain decreases in a radial direction away from the center of the fuel grain. For example, the concentration of the solid oxidizer may be highest in the first layer 180A and lowest in the third layer 180C. The concentration of the solid oxidizer may change in a direction parallel to a direction the opening passes through the center of the fuel grain. For example, the concentration of oxidizer may increase from one end (fore) of the fuel grain to the other end (aft) of the fuel grain. Having the concentration highest at the aft end of the fuel grain may be advantageous for easy ignition using a laser. The concentration of metal in the fuel grain may similarly increase in the direction parallel to the opening and/or another direction. For increased safety in storage, a cap may be placed over each end of the opening to prevent external sparks or other hot objects or concentrated light from contacting oxidizer rich inner layer of the fuel grain 180 causing combustion.

FIG. 8 is a schematic representation of a rocket 1000 with the fuel grain 180 according to an example embodiment. The design includes a linear throttling high regression rate vortex flow field injection system. The rocket 1000 that is powered by a hybrid rocket engine, which uses a linear throttling high regression rate vortex flow field injection system. The rocket is a generally cylindrical vehicle that has a generally conical nose for aerodynamics and can include fins to improve stability and control during flight in the atmosphere. The rocket 1000 may also be carrying a payload 1033.

As shown, in one implementation, the engine may be fed oxidizer from an oxidizer tank 1024 that is pressurized with a header gas from tank 1026. Although header gas is not necessary, the gas may improve engine efficiency by maintaining a consistent pressure inside the oxidizer tank 1024. In one implementation, oxidizer flows from the oxidizer tank 1024 through an injection system that includes a linear throttle valve 1018 and an injector 1010. The injector 1010 produces a vortex flow-field by translating the oxidizer flow into a centrifugal path within a pre-swirl chamber. The oxidizer then flows through injection orifices and to a fuel grain 180. This flow path forces a flame wall closer to the walls of the fuel grain 180, e.g., fuel grain, and increases a regression rate of the propellant grain.

The injection system may induce a vortex flow using flow effects observed in nature to influence the flow path and the mixing of combustion reactants and products. The created vortex may produce two different zones inside of the engine, e.g., engine 1000, one in which high axial speed combustion products are forced into a center of the vortex and a second in which lower axial speed, high centrifugal speed reactants mix on an outer section of the vortex. This flow pattern encourages combustion reaction between fuel and an oxidizer to occur as close to a wall of the propellant grain as possible to increase the regression rate of the propellant grain.

After reaction, the linear throttling high regression rate vortex flow field injection system may force the flow into the center of the vortex as the flow flows down towards a nozzle 1022 of the engine before being ejected and producing thrust. After combustion, the reactants, e.g., the fuel and oxidizer, from the reaction flow through a nozzle 1022. The axial velocity of the reactants is relatively low, increasing the total amount of time that the reactants are in the engine, which allows for a more complete combustion reaction between the reactants, e.g., the fuel and oxidizer. This process increases the efficiency of the engine as well as increases the thrust since the reactants react homogeneously with each other and directly flow through the center of the vortex.

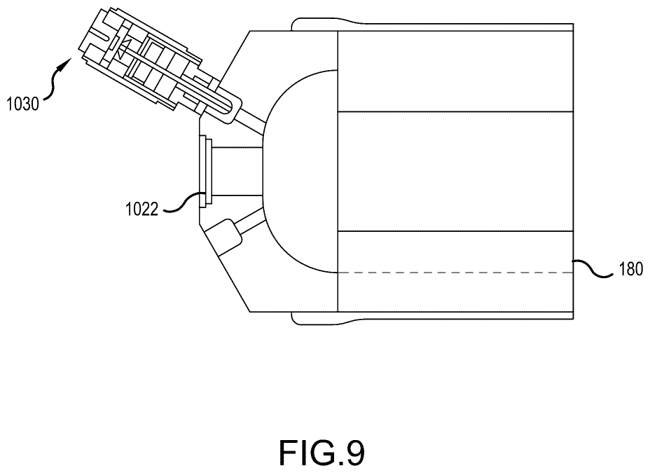

FIG. 9 shows a laser ignition for the rocket fuel grain according to an example embodiment. The laser 1030 is situated near the nozzle 1022 of the rocket and pointed at the fuel grain 180. The laser is angled to pass into the hollow center of the fuel grain 180 and contact the first layer 180A. The first layer 180A may have a highest level of oxidizer additive of any of the layers of the fuel grain 180. The presence of the oxidizer in the first layer 180A of the fuel grain 180 causes the fuel grain 180 to be easier to ignite with the laser 1030 even without the vortex flow of the oxidizer through hollow center of the fuel grain 180.

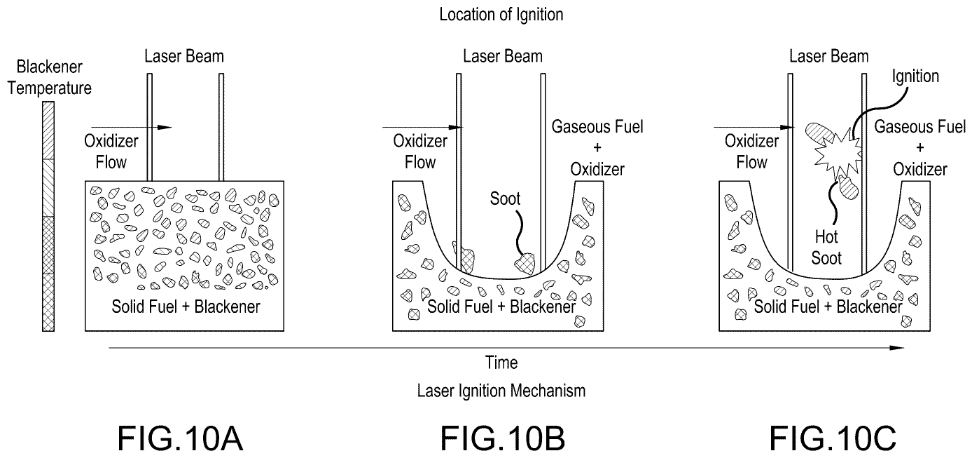

FIG. 10A-C show a laser beam igniting the rocket fuel grain according to an example embodiment. FIG. 10A shows the laser beam from the laser 1030 contacting the solid fuel and increasing the temperature of the fuel. FIG. 10B shows the solid fuel beginning to be gaseous due to the heat from the laser. FIG. 10C shows the fuel igniting when soot or other components of the fuel grain heats to a critical temperature.

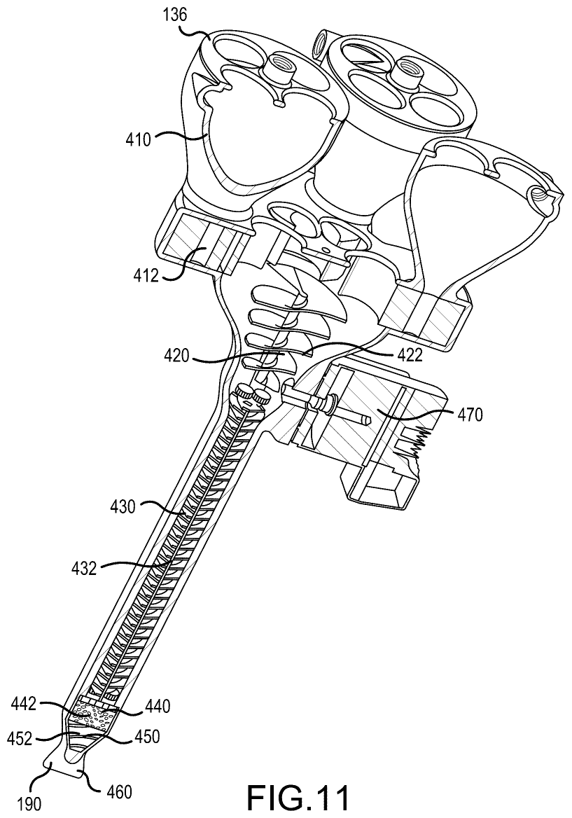

FIG. 11 is another cut away showing the inside of the print head 190 according to an example embodiment. The second hoppers 136 may include binder hoppers 410 including dispensers. The print head 190 may include a receiver 420 including an auger (or agitation screw) 422, a heating segment 430 including at least one heater 435 and one or more extruders 432, a mixing segment 440 including at least one mixer 442 and an air control system 445, a pumping segment 450 including at least one extruder, a nozzle 460, and a motor 470. Not shown in the image are a plurality of smaller motors which cause the movement of the dispensers 412, nozzle 460 and other components. The motor 470 may be connected to and provide power to the auger 422, the extruders 432, the mixer 442, and the extruder 452. The extruder barrel assembly is designed with a low aspect ratio (Length/Diameter ratio of approximately 8:1 to 12:1), significantly shorter than conventional single-screw extruders (typically 20:1 to 30:1). This compact design reduces the overall size and volume of the extrusion head, enhancing maneuverability and reducing material residence time, which is crucial for thermally sensitive materials and minimizing volatile loss.

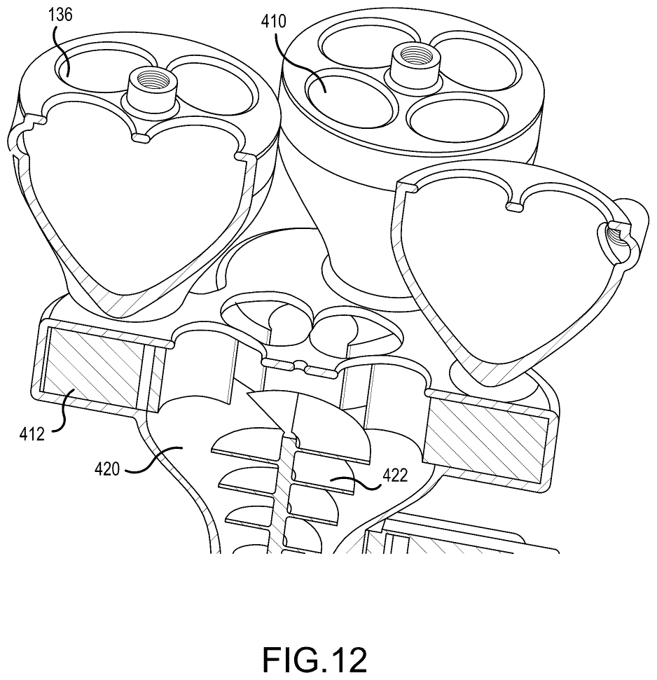

FIG. 12 is a cut away showing the inside of the upper print head 190 and second hoppers 136 according to an example embodiment. The dispenser 412 may include 3 chambers that rotate. In a first position the chambers may be filled with material from the binder hopper 410 using gravity. The chamber may then be rotated to a second position where air is removed from the chamber by the vacuum pump 425. The chamber may then be rotated to a third position where the material from the binder hopper 410 is released into the receiver 420.

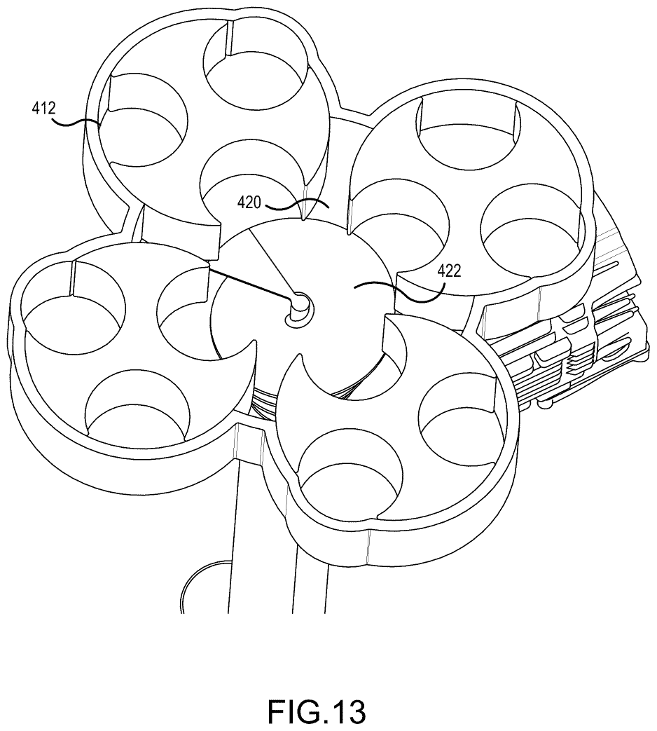

FIG. 13 is a cut away showing the rotating dispenser 412 according to an example embodiment. The rotating dispensers 412 may be formed of disks with sections cut out to form the chambers. The chambers may be sealed to prevent air leaking into the chambers as they rotate.

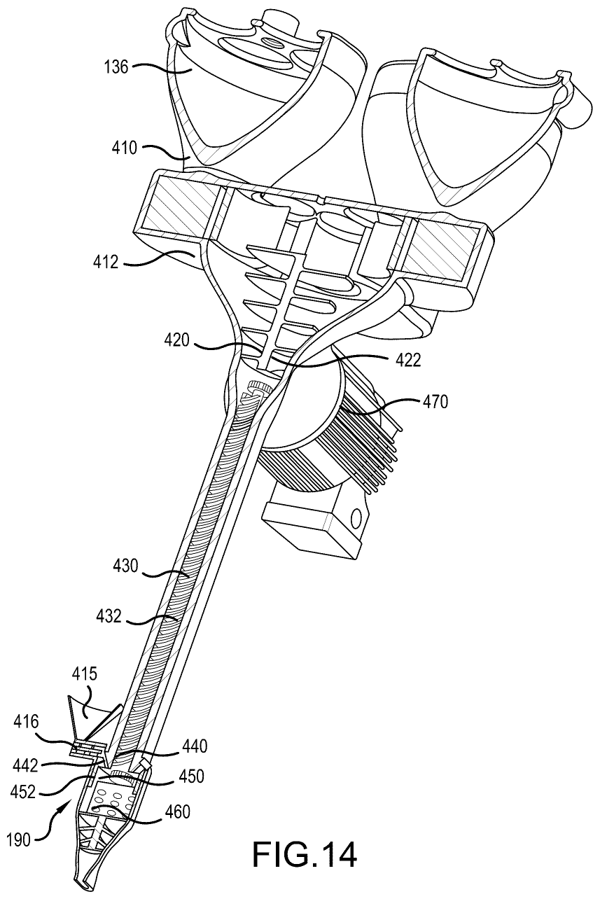

FIG. 14 is a cut away showing the inside of the print head 190 and second hoppers 136 according to an example embodiment. An additive hopper 415 with a conveyer 416 is shown. The conveyer 416 may be a gravimetric feeder.

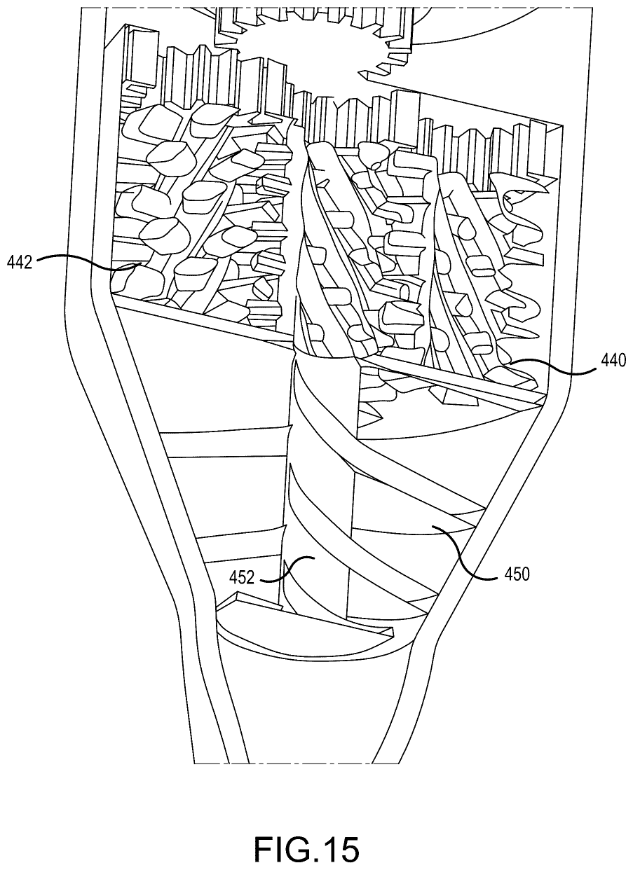

FIG. 15 is a cut away showing the inside of a mixing segment 440 and a pumping segment 450 of the printer head 190 according to an example embodiment. The mixing segment may include a plurality of pineapple mixers 442 with teeth that intertwine.

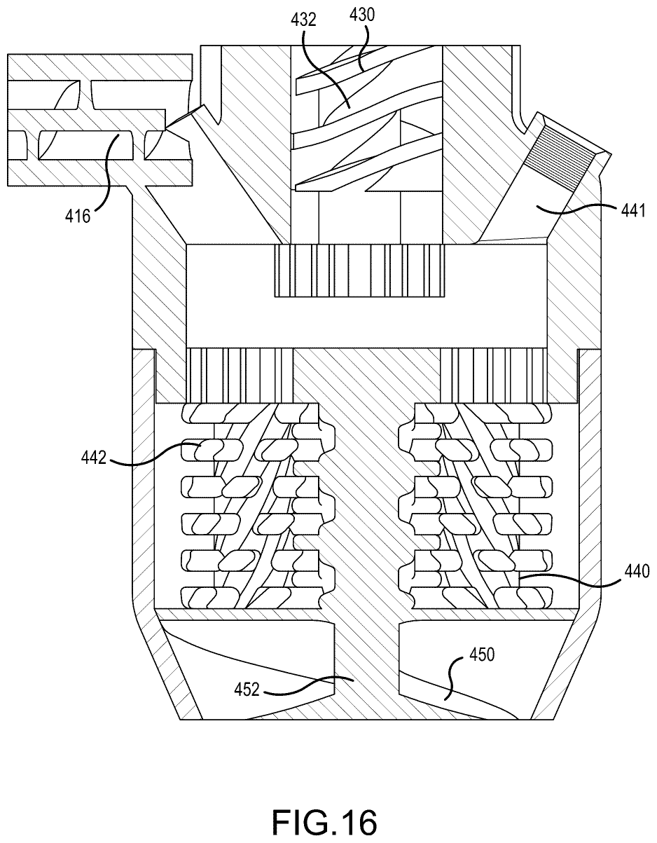

FIG. 16 is a cut away showing a connection between the mixing segment 440 and the conveyers 416 according to an example embodiment. The conveyer 416 feeds in additive. A port 441 for connection to the air control system 445 is also shown.

It should be apparent that the examples described above are exemplary and that the scope of the invention is defined solely by the appended claims which describe the invention and include such modifications that would occur to one of ordinary skill in the art.

What is claimed is:

1. A device comprising:
a print head including:
a heating segment including a heater and a first extruder, the heating segment including a first enclosed section of the print head, the heater being configured to apply heat inside the first enclosed section, the first extruder being configured to rotate, the heating segment being configured to receive binder polymer and heat the binder polymer into a liquid binder polymer;
a mixing segment including a mixer, the mixing segment including a second enclosed section of the print head, the mixing segment configured to receive the liquid binder polymer and additives in the second enclosed section and mix the liquid binder polymer and the additives to form a mixture;
a pumping segment including a second extruder, the pumping segment configured to receive the mixture and extrude the mixture; and
a nozzle, wherein the second extruder is configured to extrude the mixture through the nozzle.

2. The device of claim 1, wherein the heater is an induction type heater or a resistance type heater configured to heat the first extruder.

3. The device of claim 1, further comprising a vacuum pump configured to remove air from the print head.

4. The device of claim 1, wherein the first extruder includes a plurality of parallel screws configured to rotate to convey the binder polymer during a heating processing.

5. The device of claim 1, wherein the nozzle is configured to change at least one of width and thickness of the extruded mixture.

6. The device of claim 1, wherein the mixer includes a plurality of dynamic mixers.

7. The device of claim 1, further comprising:
a controller configured to control movement of the print head to print a fuel grain in an additive manufacturing process.

8. The device of claim 7, wherein the controller is configured to control the print head in the additive manufacturing process to change a concentration of an additive among the additives in the mixture during the additive manufacturing process.

9. The device of claim 8, wherein the controller is configured to control addition of air and a burn inhibiting additive to the binder polymer in the mixing segment.

10. The device of claim 1, further comprising:
a plurality of binder hoppers each including a dispenser, the plurality of binder hoppers each configured to hold the binder polymer, the dispenser including rotating chambers, each rotating chamber among the rotating chambers being configured to rotate to a first position where the binder polymer is received from the binder hopper, a second position where a vacuum pump is configured to remove air from the rotating chamber, and a third position where the binder polymer is conveyed to the heating segment.

11. The device of claim 10, further comprising:
a plurality of additive hoppers each including a conveyer, each of the plurality of additive hoppers configured to hold one of the additives, the conveyer configured to convey the one of the additives to the mixing segment.

12. A device comprising:
a plurality of binder hoppers each including a dispenser, the plurality of binder hoppers each configured to hold a binder polymer, the dispenser including rotating chambers, each rotating chamber among the rotating chambers being configured to rotate to a first position where the binder polymer is received from one of the plurality of binder hoppers, a second position where a vacuum pump is configured to remove air from the rotating chamber, and a third position where the binder polymer is conveyed to a heating segment; and
a print head including:
the heating segment including a heater and a first extruder, the heating segment including a first enclosed section of the print head, the heater being configured to apply heat inside the first enclosed section, the first extruder being configured to rotate, the heating segment being configured to receive binder polymer and heat the binder polymer into a liquid binder polymer; and
a nozzle configured to shape the liquid binder polymer as the liquid binder polymer exits the print head.

13. The device of claim 12, wherein the print head further includes:
a mixing segment including a mixer, the mixing segment including a second enclosed section of the print head, the mixing segment configured to receive the liquid binder polymer and additives in the second enclosed section and mix the liquid binder polymer and the additives to form a mixture; and
a pumping segment including a second extruder, the pumping segment configured to receive the mixture and extrude the mixture via the nozzle.

14. The device of claim 13, further comprising:
a plurality of additive hoppers each including a conveyer, each of the plurality of additive hoppers configured to hold one of the additives, the conveyer configured to convey the one of the additives to the mixing segment.

15. The device of claim 12, wherein the first extruder includes a plurality of parallel screws configured to rotate to convey the binder polymer during a heating processing.

16. The device of claim 12 further comprising:
a controller configured to control movement of the print head to print a fuel grain in an additive manufacturing process.

17. The device of claim 16, wherein the controller is configured to control a rotation rate of each of the rotating chambers to control a mixture composition of the liquid binder polymer.

18. A device comprising:
a plurality of binder hoppers each including a dispenser, the plurality of binder hoppers each configured to hold a binder polymer, the dispenser including rotating chambers, each rotating chamber among the rotating chambers being configured to rotate to a first position where the binder polymer is received from one of the plurality of binder hoppers, a second position where a vacuum pump is configured to remove air from the rotating chamber, and a third position where the binder polymer is conveyed to a heating segment;
a print head including:
the heating segment including a heater and a first extruder, the heating segment including a first enclosed section of the print head, the heater being configured to apply heat inside the first enclosed section, the first extruder being configured to rotate, the heating segment being configured to receive binder polymer and heat the binder polymer into a liquid binder polymer; and
a controller configured to control movement of the print head in an additive manufacturing process and a rotation rate of each of the rotating chambers to control a mixture composition of the liquid binder polymer.

19. The device of claim 18, wherein
the print head further includes:
a mixing segment including a mixer, the mixing segment including a second enclosed section of the print head, the mixing segment configured to receive the liquid binder polymer and additives in the second enclosed section and mix the liquid binder polymer and the additives to form a mixture; and
a pumping segment including a second extruder, the pumping segment configured to receive the mixture and extrude the mixture; and
the controller is configured to control a rotation rate of the first extruder, a rotation rate of the mixer, and a rotation rate of the second extruder.
